(19) United States
(12) Patent Application Publication
(10) Pub. No.: US 2013/0341289 A1
(43) Pub. Date: Dec. 26, 2013

(54) Method for Treating Waste Water

(71) Applicant: Ross Oades, Winnipeg (CA)

(72) Inventor: Ross Oades, Winnipeg (CA)

(21) Appl. No.: 13/718,371

(22) Filed: Dec. 18, 2012

Related U.S. Application Data
(60) Provisional application No. 61/663,717, filed on Jun. 25, 2012.

(51) Int. Cl. C02F 1/72

(52) U.S. Cl. CPC C02F 1/722
USPC 210/759

(57) ABSTRACT

Waste household liquid containing solid fecal content so as to include potentially toxic bacterial content is collected in a septic tank and periodically discharged through a pipe where a quantity of hydrogen peroxide is injected into the pipe to be mixed with the waste liquid. The pipe carries the liquid to a centrifugal separator to separate the solid content from the liquid so that the solid content free from toxic bacterial content is collected and the waste liquid with the solid content removed is discharged for re-use or for disposal to the ground.

This application claims the benefit under 35 USC 119 (e) of Provisional Application 61/663,717 filed Jun. 25, 2012.

This invention relates to a method for treating waste water containing solid waste and particularly household waste sewage which includes potentially toxic bacterial content.

### SUMMARY OF THE INVENTION

It is one object of the present invention to provide an improved device of this general type.

According to one aspect of the invention there is provided a method for treating waste liquid containing solid content and which includes potentially toxic bacterial content comprising:

collecting the waste liquid in a container;

periodically discharging a portion of the collected waste liquid when the container is filled to a predetermined level;

adding to the discharged portion a quantity of hydrogen peroxide which is mixed with the waste liquid containing the solid content so as to destroy the bacterial content throughout the liquid and the solid content;

centrifuging the discharged portion in a centrifugal separator to separate the solid content from the liquid;

collecting the separated solid content from the separator which is free from toxic bacterial content;

and discharging the waste liquid from the separator with the solid content removed for re-use or for disposal to the ground.

Typically the the waste liquid is household waste containing fecal matter usually from a single household but the method can be applied to larger scale systems for multiple dwellings or sub-divisions.

Preferably the discharged portion flows through a pipe from the container to the separator and the addition and mixing of the hydrogen peroxide occurs by injection in the pipe so that the mixing occurs by flow through the pipe.

One embodiment of the invention will now be described in conjunction with the accompanying drawings in which:

### BRIEF DESCRIPTION OF THE DRAWINGS

FIG. 1 is a schematic illustration of a system according to the present invention.

### DETAILED DESCRIPTION

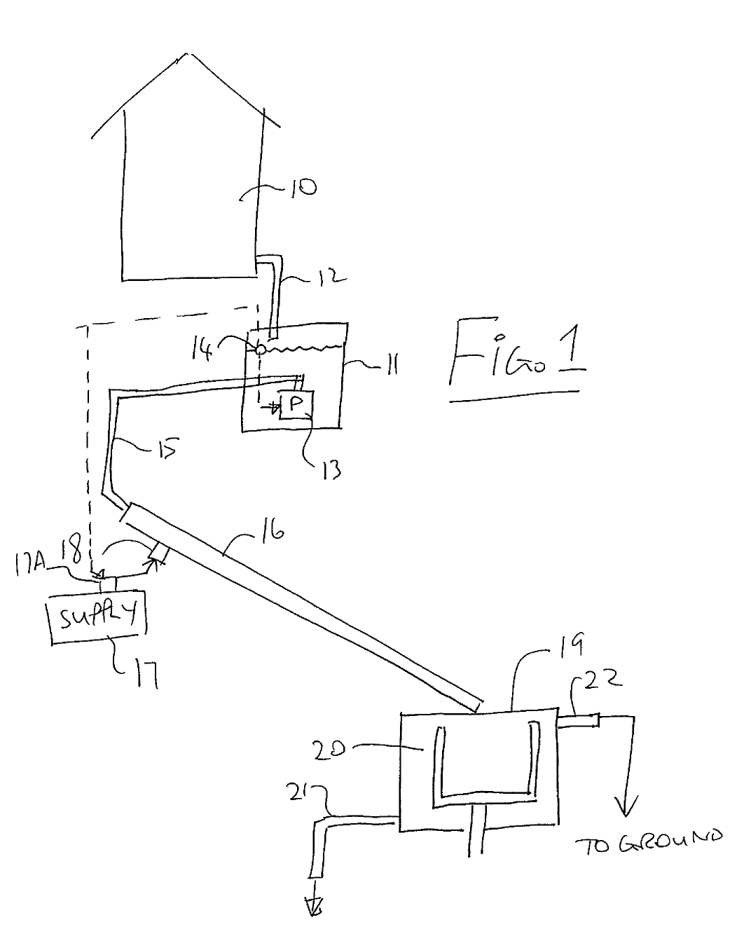

In FIG. 1 is shown a system for treating sewage from a house 10 or other larger source of sewage which provides a waste liquid containing solid content and which includes potentially toxic bacterial content.

The sewage form households generally includes solid waste particularly fecal matter and thus includes bacterial content which is potentially toxic if discharged improperly. Often such waste material, when not connected to a commercial sewage treatment plant is fed into a septic tank from which the liquid is periodically discharged into an enclosed field system containing aggregate to allow the liquid to percolate downwardly into the soil. However the bacterial content is not removed and remains in the soil for possible contamination of the soil or local water sources.

The system of the present invention includes a tank 11 for collecting the waste liquid. The tank 11 is generally underground for gravity fed though a discharge pipe 12 from the house 10. A pump 13 is provided to periodically discharge a portion of the collected waste liquid, including both the liquid and solid content, through a discharge pipe 15 when the container is filled to a predetermined level as detected by a fill sensor 14. The fill sensor is generally arranged to discharge a predetermined quantity of the liquid so that each batch delivered is of the same volume.

From the pipe 14, the liquid is fed into a feed pipe 16 where an injector 18 is provided to inject a measured quantity of hydrogen peroxide from a supply 17 where the injection into the pipe is controlled by a valve 17A controlled by the fill sensor 14 so that the valve 17A is operated to inject hydrogen peroxide as the liquid is pumped by the pump 13.

The injector thus adds to the discharged portion a quantity of hydrogen peroxide which is mixed with the waste liquid containing the solid content so as to destroy the bacterial content throughout the liquid and the solid content. The mixing action occurs in the enclosed interior of the pipe due to the swirling action of the flow in the pipe and the turbulence caused by the injection. The injection within the pipe ensures that the hydrogen peroxide remains in contact with the liquid for the oxidation process to occur without risk of the gaseous contents escaping into the atmosphere.

The hydrogen peroxide is typically supplied in an aqueous solution of concentration of 30 to 50%.

This amount has been determined to ensure that the bacterial content is destroyed or killed while avoiding excess peroxide remaining in the liquid and discharged to the ground.

From the pipe 16, the liquid is fed to a centrifugal separator 19 with a rotating centrifuge 20 for centrifuging the discharged portion to separate the solid content from the liquid. The solid content is released at a discharge 21 for collecting the separated solid content from the separator which is therefore free from toxic bacterial content and can be used as fertilizer without risk of bacterial contamination. Typically the solid content can be added to a composting arrangement for supplementing the fertilizer value.

The waste liquid from the separator is discharged at a discharge pipe 22 with the solid content removed. This can be returned to the house for re-use as it is bacteria free for re-use or more typically it is supplied to a simple field for disposal to the ground.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A method for treating waste liquid containing solid content and which includes potentially toxic bacterial content comprising:
collecting the waste liquid in a container;
periodically discharging a portion of the collected waste liquid when the container is filled to a predetermined level;
adding to the discharged portion a quantity of hydrogen peroxide which is mixed with the waste liquid containing the solid content so as to destroy the bacterial content throughout the liquid and the solid content;
centrifuging the discharged portion in a centrifugal separator to separate the solid content from the liquid;
collecting the separated solid content from the separator which is free from toxic bacterial content;
and discharging the waste liquid from the separator with the solid content removed for re-use or for disposal to the ground.

2. The method according to claim 1 wherein the waste liquid is household waste.

3. The method according to claim 1 wherein the discharged portion flows through a pipe from the container to the separator and wherein the addition and mixing of the hydrogen peroxide occurs in the pipe.

4. The method according to claim 1 wherein the hydrogen peroxide is injected into the pipe.

5. A method for treating waste liquid which includes potentially toxic bacterial content comprising:
collecting the waste liquid in a container;
periodically discharging a portion of the collected waste liquid when the container is filled to a predetermined level;
collecting the discharged portion in a second container;
adding to the discharged portion a quantity of hydrogen peroxide which is mixed with the waste liquid so as to destroy the bacterial content throughout the liquid;
wherein the discharged portion flows through a pipe from the container to the second container and the addition and mixing of the hydrogen peroxide occurs in the pipe;
and periodically discharging the waste liquid from the second container for re-use or for disposal to the ground.

6. The method according to claim 5 wherein the waste liquid is household waste.

7. The method according to claim 5 wherein the hydrogen peroxide is injected into the pipe by a metering pump.
